(19) United States
(12) Patent Application Publication
(10) Pub. No.: US 2026/0112291 A1
(43) Pub. Date: Apr. 23, 2026

(54) BUILDING GAMIFICATION AND FIRST RESPONDER AVATARIZATION METHODS FOR PREPARING AND UTILIZING AN AVATARIZED, MULTI-USER, VR TRAINING ENVIRONMENT THAT REPLICATES AN ACTUAL BUILDING

(71) Applicant: Maria Caroline Bell, Sioux Falls, SD (US)

(72) Inventor: Maria Caroline Bell, Sioux Falls, SD (US)

(21) Appl. No.: 19/351,340

(22) Filed: Oct. 7, 2025

Related U.S. Application Data
(60) Provisional application No. 63/709,709, filed on Oct. 21, 2024.

(51) Int. Cl. G09B 19/00; G01S 17/89; G06F 3/01; G06T 13/40; G06T 15/20; G09B 5/06

(52) U.S. Cl. CPC G09B 19/00; G01S 17/89; G06F 3/011; G06T 13/40; G06T 15/205; G09B 5/06

(57) ABSTRACT

A digital building twin first responder virtual reality (VR) training method is disclosed for preparing and utilizing an avatarized, multi-user VR training environment that replicates a real world building or environment for virtual training of first responders and other emergency responders. The digital building twin first responder VR training method goes beyond real-time training in the virtualized environment by recording training sessions that can later by played back for review.

### CLAIM OF BENEFIT TO PRIOR APPLICATION

This application claims benefit to United States Provisional Patent Application 63/709,709, entitled “A DIGITAL BUILDING TWIN FIRST RESPONDER VR TRAINING METHOD FOR PREPARING AND UTILIZING AN AVATARIZED, MULTI-USER, VR TRAINING ENVIRONMENT THAT REPLICATES AN ACTUAL BUILDING,” filed Oct. 21, 2024. The United States Provisional Patent Application 63/709,709 is incorporated herein by reference.

### CROSS REFERENCE TO RELATED APPLICATION

This application is related to United States Non-Provisional Patent Application Ser. No. 18/116,797, entitled “INTELLIGENT STRUCTURAL AND SPATIAL 3D REALTIME GUIDANCE AND TRAINING SECURITY SYSTEM THAT UTILIZES 3D MODELS AND 2D MAPS OF FACILITIES FOR TRAINING AND TO INFORM AND GUIDE AUTHORITIES RESPONDING TO EMERGENCIES,” filed on Mar. 2, 2023, and United States Non-Provisional patent application Ser. No. 19/330,882, which is a continuation application of United States Non-Provisional patent application Ser. No. 18/116,797 and is entitled “INTELLIGENT STRUCTURAL AND SPATIAL 3D REALTIME GUIDANCE AND TRAINING SECURITY SYSTEM THAT UTILIZES 3D MODELS AND 2D MAPS OF FACILITIES FOR TRAINING AND TO INFORM AND GUIDE AUTHORITIES RESPONDING TO EMERGENCIES,” filed on Sep. 17, 2025. The United States Non-Provisional Patent Application Ser. No. 18/116,797 and the United States Non-Provisional patent application Ser. No. 19/330,882 are incorporated herein by reference.

### BACKGROUND

Embodiments of the invention described in this specification relate generally to first responder training, and more particularly, to preparation of a virtual reality (VR) gamified first responder training environment in which multiple avatarized people can train in a virtualized and gamified building that is a replica (digital twin) of a real world building in structural form and behavioral properties.

First responders who respond to emergencies are deployed to a building which they typically have not been in or trained in. This lack of knowledge of a building and lack of training in that building makes it difficult for the first responders to be efficient and take care of the crisis in an expedient manner.

The current options for virtual first responder training are not interactive, and cannot be viewed from the third person for reviewing and debriefing the training session.

Therefore, what is needed is a way to create gamified environments for training in which avatarized people can train in a virtualized building that accurately represents a real building, and in which the virtualized training can be recorded, replayed, and reviewed.

### BRIEF DESCRIPTION

Novel building gamification and first responder avatarization methods are disclosed for preparing and utilizing an avatarized, multi-user, VR training environment that simulates an actual building or environment for simulated, virtual training of users including at least first responders and other emergency responders. In some embodiments, the building gamification and first responder avatarization methods comprise a high-level building gamification and first responder avatarization method, a detailed building gamification and first responder avatarization method, and a digital building twin first responder virtual reality (VR) training method. In some embodiments, the building gamification and first responder avatarization methods include a plurality of phases comprising (i) a building gamification phase, (ii) a first responder avatarization phase, and (iii) a first responder training simulation phase.

In some embodiments, the building gamification phase comprises spatially scanning a real-world building to create an immersive 3D model of the building (“3D building model”), generating a plurality of building assets from the 3D building model, setting a plurality of structural and behavioral properties for the plurality of building assets of the 3D building model, and providing a fully gamified digital twin of the building (the “gamified building”) by applying the structural and behavioral properties of the building assets to the 3D building model.

In some embodiments, the first responder avatarization phase comprises creating avatars of first responders to simulate in the gamified building during a simulated first responder training session.

In some embodiments, the first responder training simulation phase comprises setting up a simulation training scenario, simulating the avatars of the first responders in the gamified building for the simulation training scenario, and recording the simulation.

In some embodiments, the high-level building gamification and first responder avatarization method comprises (i) generating a 3D building model by spatially scanning an actual, real-world building, (ii) exporting a plurality of asset of the 3D building model, (iii) providing and extracting the plurality of assets in a modeling platform, (iv) integrating and using the plurality of assets in the modeling platform, (v) creating a gamified unit of the 3D building model in the modeling platform, (vi) creating gamified assets by adding structural and behavioral properties to the assets of the gamified unit to simulate real-world behavior in a virtual building training environment (also referred to as the “virtual building”) that is a digital twin of the actual, real-world building, (vii) creating avatars of users, (viii) compiling the gamified unit, the gamified assets, and the avatars of the users into a simulation unit that is configured to execute the virtual building training environment on a device for a participant to engage in a simulated training session. In some embodiments, after the simulation unit is compiled, the high-level building gamification and first responder avatarization method further comprises (ix) simulating, during the simulated training session, the avatars of the users in the virtual building and (x) recording the simulated training session of the avatars in the virtual building training environment.

In some embodiments, the detailed building gamification and first responder avatarization method comprises (i) generating a 3D building model by spatially scanning an actual, real-world building with a light detection and ranging (LiDAR) scanner, (ii) generating, by exporting from the 3D building model, a plurality of assets in a modeling platform, (iii) rendering a realistic interactive environment with the plurality of assets, (iv) making adjustments, (v) making performance optimization adjustments, (vi) creating a gamified unit of the 3D building model in the modeling platform and finalizing the gamified unit in a virtual building training environment (also referred to as the “virtual building”) that is a digital twin of the actual, real-world building, (vii) registering users and managing user accounts with respect to engaging in simulated training sessions in the virtual building training environment, (viii) setting avatars for which the registered users appear in the virtual building training environment during simulated training sessions, (ix) repeating the steps (i)-(viii) for each gamified unit of other virtual building training environments intended to provide different simulation training scenarios in various gamified environments, (x) setting up a simulation training scenario by selecting a particular gamified environment for conducting a simulated training session, (xi) defining training objectives of the simulation training scenario for the users engaging in the simulated training session, (xii) configuring a plurality of particular users and/or teams of users (individually or collectively referred to as the “particular users”) with a plurality of roles for role-based scenarios while engaging in the simulated training session of the simulation training scenario, (xiii) adding randomization elements to enhance realism of the simulation training scenario by simulating unpredictable real-world incidents and events during the simulation training session, and (xiv) finalizing setup and configuration of the simulation training scenario before starting the simulation training session.

In some embodiments, finalizing setup and configuration of the simulation training scenario comprises compiling the gamified unit, the avatars, the simulation training scenario, the training objectives, the plurality of particular users, the plurality of roles, and the randomization elements into a simulation unit that is configured to execute the virtual building training environment for the plurality of particular users to engage in the particular simulation training session.

In some embodiments, the detailed building gamification and first responder avatarization method further comprises (xv) launching the simulation training session, by executing the simulation unit, and spawning a plurality of avatars, corresponding to the particular users configured to engage in the simulation training scenario, in the particular gamified environment of the virtual building, (xvi) executing the simulation training session to provide immersive, role-specific training for the particular users, (xvii) recording the entire simulation training session, (xviii) completing the simulation training scenario, (xix) ending the simulation training session, and (xx) replaying and reviewing the recording of the simulation training session, and (xxi) debriefing the particular users who engaged in the simulation training scenario and conducting performance reviews in connection with the defined training objectives for the simulation training scenario.

In some embodiments, the digital building twin first responder VR training method involves preparing and utilizing an avatarized, multi-user VR training environment that replicates a real world building or environment for virtual training of first responders and other emergency responders, In some embodiments, the digital building twin first responder VR training method comprises (i) scanning, by a light detection and ranging (LiDAR) scanner, a real-world building to generate a 3D model of the building (“3D building model”), (ii) editing the 3D building model and placing important asset information into the 3D building model to show building assets, (iii) training first responders (“users”) how to use and view the 3D building model to become familiar with the real-world building before engaging in a life-like training session, (iv) importing an E57 file of the 3D building model, generated by the LiDAR scanner, into a virtual reality software program, wherein importing the E57 file creates a virtualized model of the real-world building that is enabled for training in a particular training session, (v) creating an avatar for each user, (vi) inviting the avatars of the users into the virtualized model of the building, (vii) installing the avatars of the users in the virtualized model of the building, (viii) recording the particular training session from first and third person perspectives of each avatar. (ix) replaying the particular training session in the virtualized model of the building during a watch and record session in which each avatar watches and records the replay (“avatar-watched replay”) of the particular training session, and (x) replaying the avatar-watched replay of the particular training session to give a third person view of the particular training session.

In some embodiments, the LiDAR scanner captures LiDAR 360-degree photography imagery of every square inch of the real-world building and results in generation of the 3D building model.

In some embodiments, the building assets comprise one or more of exits, entrances, AEDs, fire extinguishers, utility shut off valves, electrical panels, doors, windows, fixtures, floors, walls, and other furnishings.

In some embodiments, installing the avatars comprises spawning the avatars in a virtualized meeting place of the virtualized model of the building. In some embodiments, the spawned avatars are configured for simultaneous use and interaction during the particular training session.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having thus described the invention in general terms, reference is now made to the accompanying drawings, which are not necessarily drawn to scale, and which show different views of different example embodiments.

FIG. 1 conceptually illustrates a high-level building gamification and first responder avatarization method in some embodiments.

FIG. 2 conceptually illustrates a detailed building gamification and first responder avatarization method in some embodiments.

FIG. 3 conceptually illustrates a continuation of the detailed building gamification and first responder avatarization method of FIG. 2.

FIG. 4 conceptually illustrates a schematic view of a 3D building model in some embodiments.

FIG. 5 conceptually illustrates a schematic view of a section of the 3D building model to gamify in some embodiments.

FIG. 6 conceptually illustrates a schematic view of the section of the 3D building model after gamification of building assets for the floor, the door, and the walls of the section in some embodiments.

FIG. 7 conceptually illustrates a schematic view of the gamified section of the 3D building model after other assets are added back in some embodimetns.

FIG. 8 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

As used herein, the terms “comprises,” “comprising,” “includes,” “including” and/or any other variation thereof, are intended to cover a non-exclusive inclusion, such that a system, process, method, article, and/or apparatus that comprises a list of elements does not include only those elements but can include other elements not expressly listed and/or inherent to such system, process, method, article, and/or apparatus.

It must also be noted that, as used in this specification and the appended claims, the singular forms “a,” “an” and “the” include plural referents unless the content clearly dictates otherwise.

Unless defined otherwise, all technical and scientific terms used herein have the same meaning as commonly understood by one of ordinary skill in the art to which the disclosure pertains. Although a number of methods and materials similar or equivalent to those described herein can be used in the practice of the present disclosure, certain preferred materials and methods are described herein.

The terms “first,” “second,” “third,” “fourth,” and the like in the description and in the claims, if any, are used for distinguishing between similar elements and not necessarily for describing a particular hierarchical, sequential, or chronological order. It is to be understood that the terms so used are interchangeable under appropriate circumstances such that the embodiments described herein are, for example, capable of operation in sequences other than those illustrated or otherwise described herein. Furthermore, the terms “comprise,” “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein.

The terms “couple,” “coupled,” “couples. ” “coupling,” and the like should be broadly understood and refer to connecting two or more elements or signals, electrically, mechanically, or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types. The absence of the word “removably,” “removable,” and the like near the word “coupled,” and the like does not mean that the given coupling is or is not removable.

Similarly, the term “communicatively connected” and the like should be broadly understood and include physical hardware device and non-physical hardware device connections for data communications, whether the communication connection is a wireless connection, a wired connection, or a combination of both wireless and wired connections.

As used herein, the terms “gamification,” “gamify,” “gamified,” and the like should be broadly understood to encompass the process of preparing a virtual environment of a building or other real-world environment having digital assets having spatial and visual geometry properties and with defined structural and behavioral properties. The resulting virtual environment involves a gamified, three-dimensional building and/or other environment that is a digital twin of a real-world building and/or other environment that is utilized in a simulation training scenario to exhibit the properties and behaviors in a lifelike manner (as one would rationally expect in a real world scenario).

Embodiments of the invention described in this specification provide building gamification and first responder avatarization methods for preparing and utilizing an avatarized, multi-user, VR training environment that simulates an actual building or environment for simulated, virtual training of users including at least first responders and other emergency responders. In some embodiments, the building gamification and first responder avatarization methods comprise a high-level building gamification and first responder avatarization method, a detailed building gamification and first responder avatarization method, and a digital building twin first responder virtual reality (VR) training method. In some embodiments, the building gamification and first responder avatarization methods include a plurality of phases comprising (i) a building gamification phase, (ii) a first responder avatarization phase, and (iii) a first responder training simulation phase.

In some embodiments, the building gamification phase comprises (i) spatially scanning a real-world building to create an immersive 3D building model, (ii) generating a plurality of building assets from the 3D building model, (iii) setting a plurality of structural and behavioral properties for the plurality of building assets of the 3D building model, and (iv) providing a fully gamified digital twin of the building (the “gamified building”) by applying the structural and behavioral properties of the building assets to the 3D building model.

In some embodiments, the first responder avatarization phase comprises (I) registering first responders as users (“registered users”), and (ii) creating avatars of the registered users in the likeness of the corresponding first responders to simulate in the gamified building during a simulated first responder training session.

In some embodiments, the first responder training simulation phase comprises (i) setting up a simulation training scenario for the registered users to engage in the gamified building during a simulation training session, (ii) spawning and simulating, in the gamified building for the simulation training scenario, the avatars of the first responders corresponding to the registered users involved in the simulation training session, and (iii) recording, from multiple referential points of view, the simulation the simulation training session from start to completion (including from the point of view of each avatar and from the point of view of a third party perspective viewing each avatar in the gamified building during the simulation training session), and (iv) enabling replay, review, and debriefing of the simulation training session for each registered user and other authorized users after the simulation training session is finished.

In some embodiments, the high-level building gamification and first responder avatarization method comprises (i) generating a 3D building model by spatially scanning an actual, real-world building, (ii) exporting a plurality of asset files of the 3D building model, (iii) providing and extracting the plurality of assets in a modeling platform, (iv) integrating and using the plurality of assets in the modeling platform, (v) creating a gamified unit of the 3D building model in the modeling platform, (vi) creating gamified assets by adding structural and behavioral properties to the assets of the gamified unit to simulate real-world behavior in a virtual building training environment (also referred to as the “virtual building”) that is a digital twin of the actual, real-world building, (vii) creating avatars of users, (viii) compiling the gamified unit, the gamified assets, and the avatars of the users into a simulation unit that is configured to execute the virtual building training environment on a device for a participant to engage in a simulated training session. In some embodiments, after the simulation unit is compiled, the high-level building gamification and first responder avatarization method further comprises (ix) simulating, during the simulated training session, the avatars of the users in the virtual building and (x) recording the simulated training session of the avatars in the virtual building training environment.

In some embodiments, the plurality of assets of the 3D building model comprises a 3D mesh object asset (OBJ), a point cloud asset (E57/XYZ), and a plurality of 2D floor plan images.

In some embodiments, the modeling platform comprises one of a 3D modeling platform, a game engine, and an immersive virtual platform. In some embodiments, the immersive virtual platform comprises Unity®. In some embodiments, the immersive virtual platform comprises Unreal® Engine. In some embodiments, the immersive virtual platform comprises Blender®. In some embodiments, the immersive virtual platform comprises Maya®.

In some embodiments, the gamified unit comprises an entirety of the 3D building model. In some embodiments, the gamified unit comprises a section of the 3D building model. In some embodiments, the gamified unit is a first gamified unit and the section is a first section of a plurality of sections of the 3D building model. In some embodiments, the high-level building gamification and first responder avatarization method further comprises creating one or more additional gamified units for the plurality of sections of the 3D building model. In some embodiments, the high-level building gamification and first responder avatarization method further comprises virtually connecting the additional gamified units to the first gamified unit. In some embodiments compiling the gamified unit, the gamified assets, and the avatars of the users into the simulation unit comprises compiling the first gamified unit and the additional gamified units virtually connected to the first gamified unit into the simulation unit.

In some embodiments, adding structural and behavioral properties to the assets of the gamified unit ensures real-world physical characteristics of the gamified assets. In some embodiments, the gamified assets include building structures such as walls, floors, doors, windows, fixtures and furnishings, and the like.

In some embodiments, creating avatars of the users comprises creating avatars or first responders in their human likeness.

In some embodiments, the recorded simulated training session is available for replay, review, and debriefing after the simulated training session is finished.

In some embodiments, the detailed building gamification and first responder avatarization method comprises (i) generating a 3D building model by spatially scanning an actual, real-world building with light detection and ranging (LiDAR) scanner, (ii) generating, by exporting from the 3D building model, a plurality of assets in a modeling platform, (iii) rendering a realistic interactive environment with the plurality of assets, (iv) making adjustments, (v) making performance optimization adjustments, (vi) creating a gamified unit of the 3D building model in the modeling platform and finalizing the gamified unit in a virtual building training environment (also referred to as the “virtual building”) that is a digital twin of the actual, real-world building, (vii) registering users and managing user accounts with respect to engaging in simulated training sessions in the virtual building training environment, (viii) setting avatars for which the registered users appear in the virtual building training environment during simulated training sessions, (ix) repeating the steps (i)-(viii) for each gamified unit of other virtual building training environments intended to provide different simulation training scenarios in various gamified environments, (x) setting up a simulation training scenario by selecting a particular gamified environment for conducting a simulated training session, (xi) defining training objectives of the simulation training scenario for the users engaging in the simulated training session, (xii) configuring a plurality of particular users and/or teams of users (individually or collectively referred to as the “particular users”) for role-based scenarios while engaging in the simulated training session of the simulation training scenario, (xiii) adding randomization elements to enhance realism of the simulation training scenario by simulating unpredictable real-world incidents and events during the simulation training session, and (xiv) finalizing setup and configuration of the simulation training scenario before starting the simulation training session

In some embodiments, finalizing setup and configuration of the simulation training scenario comprises compiling the gamified unit, the avatars, the simulation training scenario, the training objectives, the plurality of particular users, the plurality of roles, and the randomization elements into a simulation unit that is configured to execute the virtual building training environment for the plurality of particular users to engage in the particular simulation training session.

In some embodiments, the detailed building gamification and first responder avatarization method further comprises (xv) launching the simulation training session, by executing the simulation unit, and spawning a plurality of avatars, corresponding to the particular users configured to engage in the simulation training scenario, in the particular gamified environment of the virtual building, (xvi) executing the simulation training session to provide immersive, role-specific training for the particular users, (xvii) recording the entire simulation training session, (xviii) completing the simulation training scenario, (xix) ending the simulation training session, and (xx) replaying and reviewing the recording of the simulation training session, and (xxi) debriefing the particular users who engaged in the simulation training scenario and conducting performance reviews in connection with the defined training objectives for the simulation training scenario.

In some embodiments, generating the plurality of assets comprises (i) exporting an E57 file that provides precise spatial information and (ii) exporting an OBJ file that provides visual geometry information. In some embodiments, the E57 file comprises a structure point cloud. In some embodiments, the OBJ file comprises a 3D mesh with textures. In some embodiments, rendering the realistic interactive environment comprises processing meshes in the OBJ file to render the realistic interactive environment. In some embodiments, making adjustments comprises assessing visual and spatial fidelity in the E57 file and optionally making adjustments as needed.

In some embodiments, making performance optimization adjustments comprises combining meshes of like objects. In some embodiments, making performance optimization adjustments comprises baking textures and lighting. In some embodiments, making performance optimization adjustments comprises setting up level of detail (LOD) groups. In some embodiments, making performance optimization adjustments comprises making adjustments and setting parameters for optimized rendering and simulation performance.

In some embodiments, creating the gamified unit comprises adding a plurality of gameplay elements. In some embodiments, creating the gamified unit comprises adding a plurality of triggers. In some embodiments, creating the gamified unit comprises adding a plurality of events. In some embodiments, creating the gamified unit comprises adding a plurality of user interface (UI) overlays.

In some embodiments, finalizing the gamified unit in the virtual building training environment comprises testing and load balancing.

In some embodiments, setting avatars for which the registered users appear in the virtual building training environment during simulated training sessions comprises creating each avatar in the likeness of the registered user. In some embodiments, setting avatars for which the registered users appear in the virtual building training environment during simulated training sessions comprises selecting pre-existing avatars.

In some embodiments, executing the simulation training session to provide immersive, role-specific training for the particular users comprises providing options to trigger in-simulation modifications. In some embodiments, the in-simulation modifications comprise injecting new hazards. In some embodiments, the in-simulation modifications comprise altering objectives during the simulation training session. In some embodiments, the in-simulation modifications comprise escalating situations in the simulation training scenario during the simulation training session.

In some embodiments, the building gamification and first responder avatarization methods go beyond real-time training in the virtualized environment by recording training sessions that can later by played back for review. In some embodiments, the recorded training sessions provide a third-person perspective for each avatar/user to replay and view their actions within the virtual training session. In some embodiments, the third-person perspective recording is actuated by an additional avatar corresponding to the user's avatar. In some embodiments, the additional avatar is configured to only record the session and is not visible in the virtualized environment by other users/avatars in the training session. In this way, the replay of the training session for each user/avatar is possible from a third person point of view. Furthermore, the team of users/avatars in the training session are able to replay the recorded third person perspectives of different non-visible recording avatars, thereby providing a way to view replays of the training session from multiple angles to assist debriefing, correcting, adjusting, etc., aspects in the training session.

In some embodiments, the building gamification and first responder avatarization methods provide a true-to-life digital representation of a real-world building (which is referred to as a “digital twin” or “virtual twin” of the building or as a “digital building twin” or simply the “virtual building”). Specifically, the accuracy of the virtual building replicates acoustics and physical dynamics of the real-world environment in terms of the known physics of the actual physical materials used to construct the real-world building.

As stated above, first responders who respond to emergencies are deployed to a building which they typically have not been in or trained in. This lack of knowledge of a building and lack of training in that building makes it difficult for the first responders to be efficient and take care of the crisis in an expedient manner. However, the existing options for virtual first responder training are not interactive, and cannot be viewed from the perspective of third parties for reviewing and debriefing the training session. Embodiments of the building gamification and first responder avatarization methods described in this specification solve such problems by creating the digital twin of the building via LiDAR (Light Detection and Ranging) scanning within the actual real-world building and combining the LiDAR scan with an E57 file of 360-degree photography of the real-world building. Since the E57 file format is a standardized, vendor-neutral file type that stores key data produced by 3D imaging systems (e.g., point cloud data, images, and metadata), such as the data produced by 3D imaging from 360-degree photography. Furthermore, E57 is a commonly-used format in various applications related to architecture, engineering, and construction (AEC).

The resulting 3D model that is created is immersive and allows first responders to see the detail/inside of a building. This is possible by importing the E57 files into immersive VR software. Additionally, by creating Avatars of the first responders (users), it is possible to host a real-time multiplayer training session for many first responders within the real virtualized building. An additional feature is that the real-time virtualized training session can be recorded, and the avatars (users) can watch a replay of their training which, when replayed, provides a third person point of view for the user to understand their actions in the original training session.

Embodiments of the building gamification and first responder avatarization methods described in this specification differ from and improve upon currently existing options. In particular, the current virtual training software for first responders involve fabricated scenarios within fabricated buildings and gamified scenarios. Specifically, the existing options do not utilize the actual buildings that the first responders would be called to defend during emergencies. By contrast, the building gamification and first responder avatarization methods involve true-to-life replicas of real buildings that first responders would actually be called to in emergency situations. Also, the building gamification and first responder avatarization methods are configured to be utilized by many avatars/users simultaneously, thereby providing an efficient way to train several (e.g., 25-75 or more) first responders at any given time.

The building gamification and first responder avatarization methods of the present disclosure are noted above as included both a high-level method and a detailed method. Broadly, the building gamification and first responder avatarization methods also include a digital building twin first responder VR training method that may be comprised of the following elements. This list of possible constituent elements is intended to be exemplary only and it is not intended that this list be used to limit the digital building twin first responder VR training method of the present application to just these elements. Persons having ordinary skill in the art relevant to the present disclosure may understand there to be equivalent elements that may be substituted within the present disclosure without changing the essential function or operation of the digital building twin first responder VR training method or either of the building gamification and first responder avatarization methods.
1. Scanning the building via LiDAR 360 photography scan of every square inch of a building (resulting in a 3D model of the building).
2. Editing the 3D model and placing important asset information into the model showing things like exits, entrances, AEDs, fire extinguishers, utility shut off valves, electrical panels, etc.
3. Training first responders how to use/view the 3D model to become familiar with it.
4. Importing the E57 file (an OBJ mesh file for 3D environment) into a virtual reality software program.
5. Creating an avatar for each first responder with an account, optionally adding facial likeness imagery to the avatar.
6. Inviting avatar first responders into the virtualized model.
7. Installing multiple avatars into the model for simultaneous use and interaction during a training session, which may involve any of several different kinds of scenarios involving first responders, assailants, victims, etc., such as a hostage situation, a robbery, an active shooter scenario, etc. Typical use-case scenarios commonly support 25-75 avatarized first responders simultaneously training in the same session.
8. Recording the training session (audio and visual recordings, or combined audio/visual recordings, from first and third-person perspectives).
9. Replaying the training session in the virtual world and have the avatar watch the replay and record.
10.Replaying the avatar-watched replay of the training to give a third person view of the training.

The various elements of the digital building twin first responder VR training method may be related in the following exemplary fashion. It is not intended to limit the scope or nature of the relationships between the various elements and the following examples are presented as illustrative examples only.

The first step for scanning of the “real” building is the basis for all following steps. Editing the resulting 3D model (in the second step) is vital for many types of training sessions because key assets which are present in the real-world building can be added to the virtualized building so that the first responders are provided with visual information to virtually familiarize themselves without having to go to the physical building. Notably, there may be additional updates to the model if needed, so the second step may be repeated as needed before training, or repeated over time if and when things change in the real-world building. Similarly, if and when there are structural updates to the real-world build, the first step can be repeated to scan a new version of the building.

After the model is created and assets added, training can be conducted in a virtualized environment. If the first responders are unfamiliar with the virtualized environment, they may engage in training (this is the third step). Training in the virtualized environment is not intended to be building-specific, but is general for operating within the virtual reality (VR) program which hosts the virtual representation of the real-world building. Nevertheless, if preferred, the training can happen within the virtual building. In this way, the first responders can become familiar with the building layout.

During the fourth step, the E57 file is imported into the VR program. The E57file provides the relevant structural data of the building. Ultimately, importing the E57 allows generation of the virtual digital building as a virtual meeting place in which multiple avatars/users may engage in the same training session. Thus, during the fifth step, avatars of first responders and other people are created. The first responders and others (collectively referred to as the “users”) are the key personnel who will be involved in the training. In order to create their respective avatars, each user would need to create an account. In some embodiments, the avatar creation step involves capturing and creating a like facial image of the user with the facial image bearing a high degree of resemblance to a view of the real person's face.

After creation of the avatars for the users, these avatars are ‘invited’ to the virtual digital building (that is, the virtual meeting room). In some embodiments, all avatars are “spawned” into the model at the same place. Thus, the virtual meeting room may be a particular room within the building, or may be just outside of an entrance to the building. The place where the avatars are spawned is configurable such that different training sessions can start at different locations.

At the next stage, starting with the seventh step, multiplayer interaction occurs. Furthermore, the session is recorded such that visual and audible recordings (or combined audio/visual recording) of the session occurs. This provides the third person perspective, as is described above, for later playback and viewing by the users or others. In some embodiments, haptic signals are associated with avatars in which the corresponding users operate hand controllers or other real-world devices to move their avatar within the VR world. While the number of haptic signals may be limited, they are relevant to the interaction that occurs within the VR world since the avatar corresponding to a user who is operating a controller device with haptic feedback would be triggered to engage some kind of movement or action in the VR world based on the particular haptic signal.

The training session itself is fully recorded during the eighth step. As noted above, each avatar may have a corresponding non-visible recording avatar that provides the third person perspective of the avatar. As there are several avatars in the VR world during the training session, the user is able to review the recordings from the perspective of third persons from all angles. In the ninth step, each avatar can replay the recorded training session from its own first person perspective throughout the session. For the tenth step, the recording can be replayed of the avatar watching its own avatar to show the training from the third person.

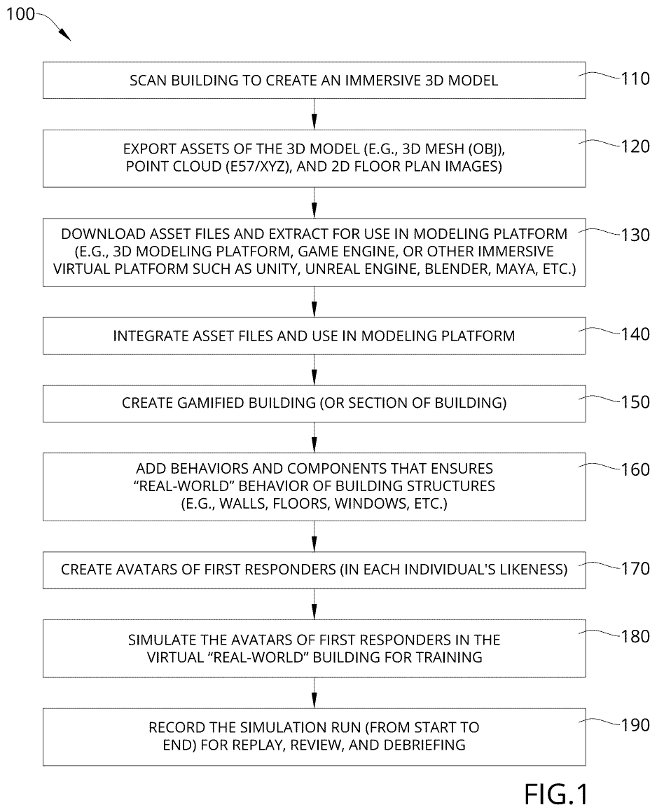

To make and use the digital building twin first responder VR training method of the present disclosure, one may follow the steps broadly outlines above. In particular, the first step (Step 1) involves scanning the actual building to create a digital model that serves as the foundation for subsequent steps. In some embodiments, scanning the building is done by a LiDAR scanner with the addition of 360 photography. The subsequent data point cloud which is generated is formatted in an E57 file. Then the data point cloud model (or “3D model”) may be edited (Step 2) to place assets into the model for first responders. The model is typically going to be edited to allow first responders to virtually explore the building and familiarize themselves with its assets without physically being present. The editing of the 3D model may be done via a suitable 3D modeling software program. During this editing stage, the assets may tagged. In some embodiments, tagging the assets ensures they are searchable for quick identification. Note that the digital building twin first responder VR training method described here is a broad method that can be implemented to carry out the entire preparation of the gamified building and simulated training scenario. However detailed examples of both high-level and detailed building gamification and first responder avatarization methods are described below, by reference to FIGS. 1-3.

At this point, the 3D model can be used to familiarize the first responders with the building. Thus, the focus of Step 3 is on training the first responders using the virtual model, ensuring they are familiar with the building layout before any real-life emergencies occur. However, the 3D model is not yet configured to allow multiplayer real time training. In order to do multiplayer real time training, a virtual reality software program may be utilized. Thus, during Step 4, the E57 file would be uploaded into the virtual reality software program to create a real “virtualized” meeting place (the “digital building twin”).

After creating the meeting place, each individual responder may need to register with the virtual reality software program (if not already registered) in order to create their own avatar, which occurs during Step 5. As noted above, creation of the avatars is performed for users with accounts (including both first responders and other individuals involved in the training). As an option, the likeness of each user's facial image is generated for their respective avatar.

Once the avatars are created, the avatars/users can be invited (at Step 6) to join the other avatars/users, in real-time, in the virtual meeting room of the digital building twin. As explained above, the avatars themselves are spawned into the 3D model at the same place (that is, in the virtual meeting room).

After spawning of the avatars, multiplayer interaction with visual and audio recording capabilities is initiated (at Step 7), such that interactive training can occur anywhere in that virtualized building. For instance, an avatar of a first user ‘walks’ through a first hallway of the building while the avatar of a second user ‘walks’ through a different hallway to a different section of the building. Furthermore, Step 7 includes the limited haptic signaling options available through the hand controllers for avatar movement. While it is possible to have a single avatar/user engage in the VR space, a typical training session would include multiple avatars (e.g., 2-75 simultaneous avatars/users) engaging interactively in the VR space at the same time.

While this is happening, the training session is recorded (Step 8) for review and analysis. Specifically, audio and video recording is done through the “eyes” of the avatar for a first person perspective and through the “eyes” of a non-visible corresponding avatar for a third party/third person perspective of the avatar utilized by the user. The avatar can then “replay” and watch and record itself. In Step 9, each avatar/user is directed to replay the training session and follow their own avatar throughout the session. Finally, Step 10 of the digital building twin first responder VR training method includes replaying (playback of) the recording of the avatar watching its own avatar to provide a third-person perspective of the training session The final recording provides both first person and third person perspectives of the avatar(s), ensuring a comprehensive learning experience for the first responders.

With the broadly covered digital building twin first responder VR training method described above, one is introduced to several key aspects. In the next section, more details are provided by reference to FIGS. 1-7. First, and by way of example, FIG. 1 conceptually illustrates a high-level building gamification and first responder avatarization method 100. The high-level building gamification and first responder avatarization method 100 may be performed, at least in part, by one or more computing devices that implements one or more steps in software.

As shown in this figure, the high-level building gamification and first responder avatarization method 100 starts with a building being scanned to create an immersive 3D model (at 110). The building is scanned spatially by way of remote detection instrumentation, such as active sensors (e.g., LiDAR or radar) or other passive sensors (e.g., photosensitive sensors and the like). Once the spatial scan is completed, the immersive 3D model is available. The 3D model includes several different 3D model assets including, at least, a 3D mesh asset (OBJ), a point cloud asset (E57/XYZ), and one or more two-dimensional (2D) floor plan images. Thus, the high-level building gamification and first responder avatarization method 100 exports the 3D model assets (at 120). Then the high-level building gamification and first responder avatarization method 100 moves onto the next step for downloading asset files (OBJ file, E57 file, 2D floor plan image filed, etc.) and extracting them for use in a modeling platform (at 130). Examples of the modeling platform include, without limitation, Unity®, Unreal® Engine, Blender®, and Maya®.

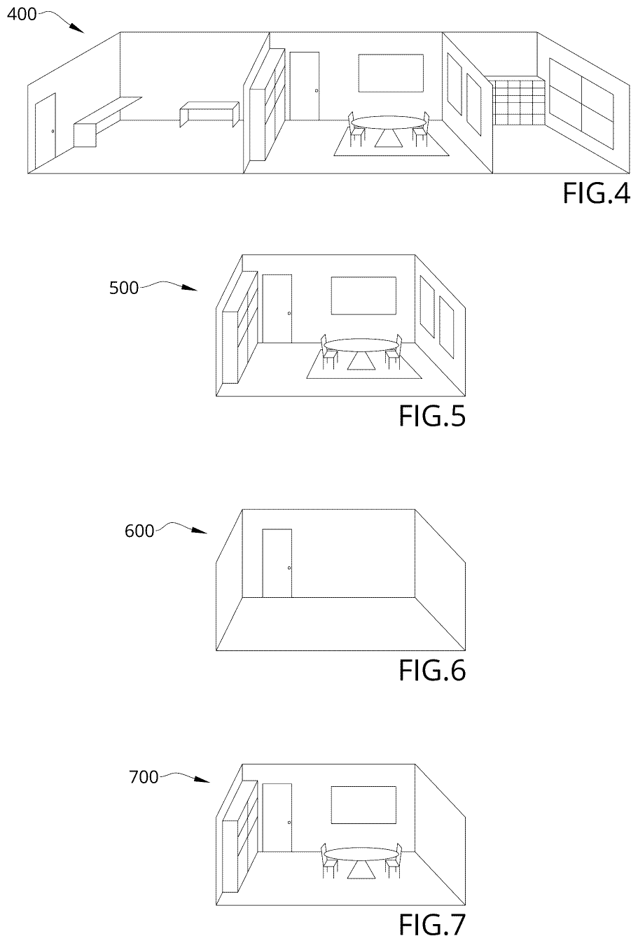

In some embodiments, the high-level building gamification and first responder avatarization method 100 then integrates the asset files within the modeling platform and uses the integrated asset files within the modeling platform (at 140). An example of the 3D building model with multiple assets (e.g., rooms, floor plans, walls, doors, windows, fixtures, and furnishings) is described below, by reference to FIG. 4. At this point, the original spatial scan of the building and the resulting preliminary asset work on the 3D model are completed and the entire virtual building can be prepared for simulation by setting structural and behavioral properties of the assets which “gamify” the building in ways that replicate structural and behavioral properties of their real-world correlates.

Thus, the high-level building gamification and first responder avatarization method 100 does so at the step for creating the gamified building (at 150). In some embodiments, creating the gamified building (at 150) comprises creating a gamified section of the building in the 3D model. In some embodiments, the section of the building is the entire building. In some embodiments, the building shown in the 3D model includes multiple sections (also referred to as building units). An example of an individual building section within the 3D building model (with multiple assets) is described below, by reference to FIG. 5. Thus, when the 3D building model includes several independent sections, the high-level building gamification and first responder avatarization method 100 may create and process each of the multiple gamified sections of the building (at 150), which are later combined to represent the entire gamified building. An

Next, the high-level building gamification and first responder avatarization method 100 continues to the step for adding structural and behavioral properties to the assets (at 160). For example, setting properties that allow windows and doors to be opened and closed, setting walls so that avatarized users cannot virtually walk through them, and setting floors as supporting users walking, running, jumping on them, and so on, without falling through them. In some embodiments, one or more other assets are removed to set the relevant structural and behavioral properties. An example of a section of a 3D building model with some assets removed and other assets (door, floor, and walls) being ‘gamified’ with expected real-world structural and behavioral properties is described below, by reference to FIG. 6. Also, an example of adding the other assets back to the gamified section of the 3D building model is described below, by reference to FIG. 7.

After adding the structural and behavioral properties to the assets of the section of the 3D building model, the high-level building gamification and first responder avatarization method 100 moves on to a step for creating avatars of the first responders (at 170). In some embodiments, the avatars are created in the likeness of the corresponding first responders. In some embodiments, the avatars are pre-existing, generic avatars that are selected for the first responders.

After the gamified building is created, the structural and behavioral properties of the gamified assets are established, and the avatars of the users are created, a simulation unit is compiled for execution on a supported device. Supported devices are those which include a screen for display of the virtual environment, such as VR goggles, AR devices, mobile devices, etc.

The high-level building gamification and first responder avatarization method 100 includes additional runtime steps after the simulation unit is compiled and ready for execution. Specifically, the high-level building gamification and first responder avatarization method 100 includes a step for simulating the avatars of the first responders in the virtual “real-world” building for training (at 180) when the simulation unit is executing on a device. For instance, one may launch the simulation unit to start the simulation training session for one or more users (the “participants” who are configured to participate in the simulation training scenario), and the simulation unit may automatically load the avatars (also referred to as “spawning” the avatars) of the participants. Additionally, the high-level building gamification and first responder avatarization method 100 includes another step for recording the simulation training session (at 190) while the simulation unit is executing. In particular, the session may be recorded from start to finish so that the recorded simulation training session can be replayed, reviewed, and used in debriefing and/or performance reviews, etc. Then the high-level building gamification and first responder avatarization method 100 ends.

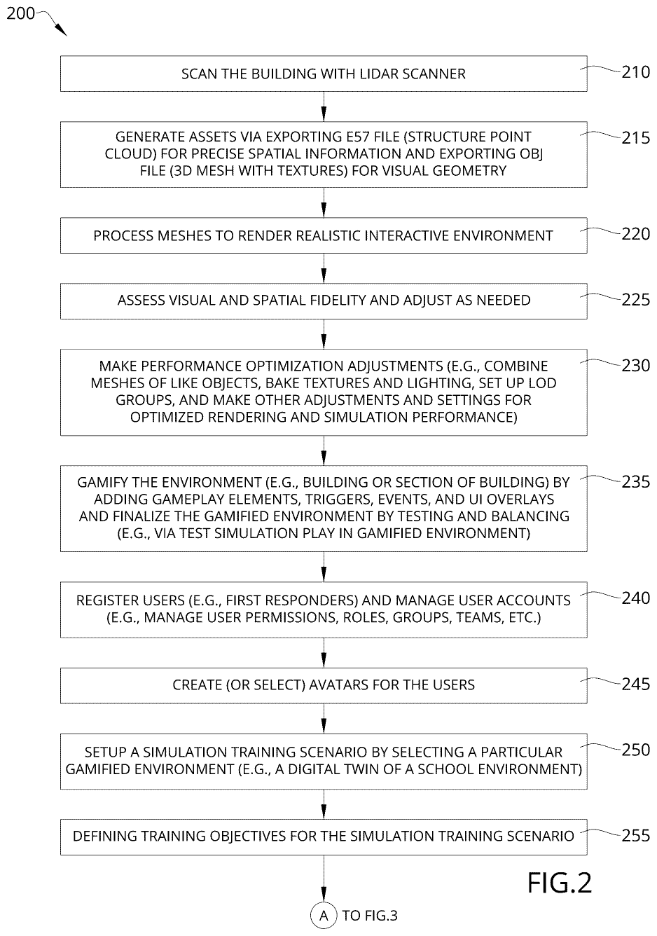

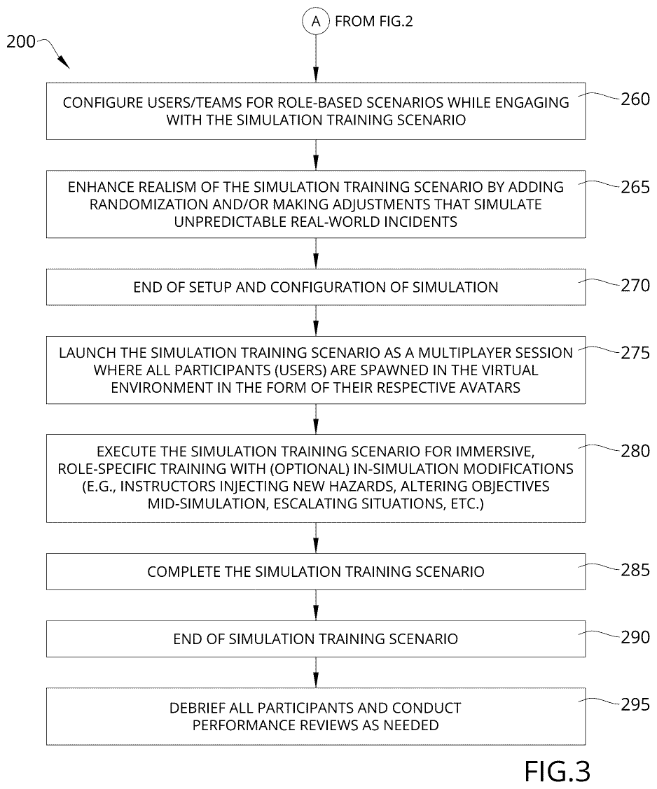

Turning to another example, the detailed building gamification and first responder avatarization method 200 is described next, by reference to FIGS. 2-3. As shown in these figures, the detailed building gamification and first responder avatarization method 200 starts by generating a 3D building model of a building that is spatially scanned with a light detection and ranging (LiDAR) scanner (at 210). This is followed by the detailed building gamification and first responder avatarization method 200 generating, by exporting from the 3D building model, a plurality of assets in a modeling platform (at 215). In particular, the detailed building gamification and first responder avatarization method 200 generates assets for exports from an E57 file, namely a structure point cloud, which provides precise spatial information. Additionally, the detailed building gamification and first responder avatarization method 200 generates still more assets for exports from an OBJ file, namely a 3D mesh with texture data, which provides visual geometry information.

Next, the detailed building gamification and first responder avatarization method 200 proceeds to steps for processing the meshes to render a realistic interactive environment (at 220) and assessing the visual and spatial fidelity based on the spatial information and the visual geometry information (at 225). In some embodiments, the detailed building gamification and first responder avatarization method 200 the step for assessing (at 225) also includes the option of making adjustments as needed.

Then the detailed building gamification and first responder avatarization method 200 proceeds to a step for making performance optimization adjustments (at 230). In particular, the performance optimization adjustments include, without limitation, combining meshes of like objects, baking in the textures and lighting elements, setting up LOD groups, and making various other adjustments and settings for optimized rendering and simulation performance.

Now, the detailed building gamification and first responder avatarization method 200 is ready for gamifying the environment (at 235). Specifically, gamifying the environment (at 235) involves creating a gamified unit of the 3D building model in the modeling platform and finalizing the gamified unit in a virtual building training environment (also referred to as the “virtual building”) that is a digital twin of the actual, real-world building. Additionally, gamifying the environment (at 235) may involve adding gameplay elements, triggers, events, and UI overlays to the gamified unit. Also, finalizing the gamified unit may involve testing and balancing operations such as, without limitation, performing test simulation runs with active user engagement and interaction (“playing”) in the gamified environment.

Next, the detailed building gamification and first responder avatarization method 200 proceeds to a step for registering users and managing user accounts (at 240) with respect to engaging in simulated training sessions in the virtual building training environment. For example, managing user permissions, setting roles and role-based permissions of users, setting up and managing groups, such as LOD groups or other teams, etc. After registering the users and managing the user accounts, the detailed building gamification and first responder avatarization method 200 moves forward to the next step for creating avatars for the users (at 245). The avatars are created for the registered users as there individual visual representation within the gamified building environment. In other words, the avatars are how the users appear in the virtual building training environment during simulated training sessions.

At this point, the detailed building gamification and first responder avatarization method 200 may repeat the above steps (at 210-245) for each gamified unit or for various other virtual building training environments intended to provide different simulation training scenarios in various gamified environments. For example, different 3D building models are going to have different assets that need to be gamified and different user groups may be registered and/or set for participation on the corresponding simulation training sessions of those gamified environments—each of which may represent a different simulation training scenario. For instance, one such simulation training scenario may be configured from a digital twin of a school environment in which an active shooter is present and first responders need to engage in training to know the exact internals of the school building. Then the detailed building gamification and first responder avatarization method 200 proceeds to the next step for setting up the simulation training scenario (at 250) by selecting a particular gamified environment for conducting a simulated training session.

After the simulation training scenario is decided on and the particular gamified environment is selected for conducting the simulated training session, the detailed building gamification and first responder avatarization method 200 of some embodiments moves forward to a step for defining training objectives of the simulation training scenario (at 255) for the users configured to participate and engage in the simulated training session. The users intended to participate and engage in the simulated training session are then determined when the detailed building gamification and first responder avatarization method 200 performs a step for configuring a plurality of particular users for role-based scenarios (at 260) while engaging in the simulated training session of the simulation training scenario.

Optionally, the detailed building gamification and first responder avatarization method 200 may perform a step to enhance realism during the simulation training session by randomly adding, removing, and/or changing elements in the environment to provide a simulated sense of unpredictable real-world incidents and events occurring during the simulation training session (at 265). Then the detailed building gamification and first responder avatarization method 200 ends the setup and configuration phase (at 270), which finalizes setup and configuration of the simulation training scenario before starting the simulation training session.

In some embodiments, the detailed building gamification and first responder avatarization method 200 ends the setup and configuration phase (at 270) by compiling one or more of the gamified unit, the avatars, the simulation training scenario, the training objectives, the plurality of particular users, the plurality of roles, and the randomization elements into a simulation unit that is configured to execute the virtual building training environment for the plurality of particular users to engage in the particular simulation training session.

After the finalization step (at 270), the detailed building gamification and first responder avatarization method 200 transitions to a step for launching the simulation training session, by execution of the simulation unit, and spawning a plurality of avatars (at 275). In particular, the simulation is launched after the simulation unit is executing on one or more devices and when the particular users corresponding to the avatars are logged in and ready to start. In this way, the particular users are able to interact and engage in the simulation training scenario in the particular gamified environment of the virtual building. Thus, the detailed building gamification and first responder avatarization method 200 executes the simulation training session (at 280) to provide immersive, role-specific training for the particular users. Additionally, the detailed building gamification and first responder avatarization method 200 may continuously record the entire simulation training session from start to finish. After completing the simulation training scenario (at 285), the detailed building gamification and first responder avatarization method 200 ends the simulation training session (at 290). Then, post-simulation activities may ensue, including, for example, replaying and reviewing the recording of the simulation training session, as well as debriefing the particular users who engaged in the simulation training scenario and conducting performance reviews in connection with the defined training objectives for the simulation training scenario (at 295). Then the detailed building gamification and first responder avatarization method 200 ends.

By way of example, FIG. 4 conceptually illustrates a schematic view of a 3D building model 400 as might be represented for an actual, real-world building after a spatial scan of the building by LiDAR or other spatial scanning method. On the other hand, FIG. 5 conceptually illustrates a schematic view of a building section 500 of the 3D building model 400. The building section 500 shown in this figure is individual isolated to prepare for gamifying the assets within the building section 500.

Now, turning to FIG. 6, a schematic view of a bare-bones building section 600 of the 3D building model 400 is shown after virtual removal of fixtures and furnishings to focus on gamification of the other structural assets in the bare-bones building section 600, namely, the floor, the door, and the walls of the bare-bones building section 600. FIG. 7 conceptually illustrates the gamified building section 700 after the fixtures and furnishings are re-added. While the examples demonstrated in FIGS. 5-7 focus only on a single building section, it is understood that the process of gamifying each of the other sections of the 3D building model 400 would happen in a similar manner.

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

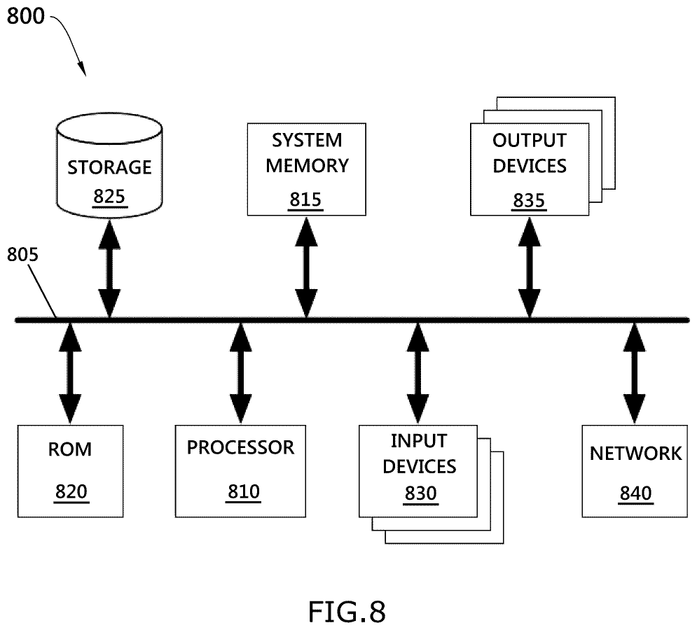

By way of example, FIG. 8 conceptually illustrates an electronic system 800 with which some embodiments of the invention are implemented. The electronic system 800 may be a computer, phone (cell phone, mobile phone, smartphone, etc.), PDA (iPod, other handheld computing device, etc.), VR goggles, AR devices, or any other sort of electronic device or computing device. Such an electronic system includes various types of computer readable media and interfaces for various other types of computer readable media. Electronic system 800 includes a bus 805, processing unit(s) 810, a system memory 815, a read-only memory 820, a permanent storage device 825, input devices 830, output devices 835, and a network 840.

The bus 805 collectively represents all system, peripheral, and chipset buses that communicatively connect the numerous internal devices of the electronic system 800. For instance, the bus 805 communicatively connects the processing unit(s) 810 with the read-only memory 820, the system memory 815, and the permanent storage device 825.

From these various memory units, the processing unit(s) 810 retrieves instructions to execute and data to process in order to execute the processes of the invention. The processing unit(s) may be a single processor or a multi-core processor in different embodiments.

The read-only-memory (ROM) 820 stores static data and instructions that are needed by the processing unit(s) 810 and other modules of the electronic system 800. The permanent storage device 825, on the other hand, is a read-and-write memory device. This device 825 is a non-volatile memory unit that stores instructions and data even when the electronic system 800 is off. Some embodiments of the invention use a mass-storage device (such as a magnetic or optical disk and its corresponding disk drive) as the permanent storage device 825.

Other embodiments use a removable storage device (such as a floppy disk or a flash drive) as the permanent storage device 825. Like the permanent storage device 825, the system memory 815 is a read-and-write memory device. However, unlike storage device 825, the system memory 815 is a volatile read-and-write memory, such as a random access memory. The system memory 815 stores some of the instructions and data that the processor needs at runtime. In some embodiments, the invention's processes are stored in the system memory 815, the permanent storage device 825, and/or the read-only memory 820. For example, the various memory units include instructions for processing meshes of the files from 3D building model scans or other visual geometry information therein. From these various memory units, the processing unit(s) 810 retrieves instructions to execute and data to process in order to execute the processes of some embodiments.

The bus 805 also connects to the input and output devices 830 and 835. The input devices enable the user to communicate information and select commands to the electronic system. The input devices 830 include alphanumeric keyboards and pointing devices (also called “cursor control devices”). The output devices 835 display images generated by the electronic system 800, such as the virtual building/environment and other visual aspects of the simulation training scenario. The output devices 835 include display devices, such as virtual reality (VR) goggles, augmented reality (AR) eye-wear devices, and/or mixed reality (XR) devices, as well as conventional display technology, such as, without limitation, liquid crystal displays (LCD) and organic light emitting diode (OLED) displays. Some embodiments include devices such as a touchscreen that functions as both input and output devices.

Finally, as shown in FIG. 8, bus 805 also couples electronic system 800 to a network 840 through a network adapter (not shown). In this manner, the electronic system 800 can be a part of a computer network (such as a local area network (“LAN”), a wide area network (“WAN”), or an intranet), or a network of networks. Any or all components of electronic system 800 may be used in conjunction with the invention.

The functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIGS. 1-3 conceptually illustrate methods in which the specific operations of each method may not be performed in the exact order shown and described. Specific operations may not be performed in one continuous series of operations, and different specific operations may be performed in different embodiments. Furthermore, each method could be implemented using several underlying methods or sub-processes, or as part of a larger macro method or process. Thus, one of ordinary skill in the art would understand that the invention is not to be limited by the foregoing illustrative details, but rather is to be defined by the appended claims.

I claim:

1. A building gamification and first responder avatarization method for preparing and utilizing an avatarized, multi-user, virtual reality (VR) training environment that simulates an actual building or environment for simulated, virtual training of first responders, said building gamification and first responder avatarization method comprising:
generating a three-dimensional (3D) building model of a real-world building;
exporting a plurality of assets of the 3D building model;
providing the exported plurality of assets in a modeling platform;
integrating the plurality of assets in the modeling platform;
creating a gamified unit of the 3D building model in the modeling platform;
creating gamified assets by adding structural and behavioral properties to the assets of the gamified unit to simulate real-world behavior in a virtual building training environment;
creating avatars of users; and
compiling the gamified unit, the gamified assets, and the avatars of the users into a simulation unit that is configured to execute the virtual building training environment on a device for a participant to engage in a simulated training session.

2. The building gamification and first responder avatarization method of claim 1, wherein generating the 3D building model comprises spatially scanning the real-world building.

3. The building gamification and first responder avatarization method of claim 1, wherein spatially scanning the real-world building comprises utilizing a light detection and ranging (LiDAR) scanner.

4. The building gamification and first responder avatarization method of claim 1, wherein the gamified unit comprises a section of a plurality of sections of the 3D building model.

5. The building gamification and first responder avatarization method of claim 1, wherein the virtual building training environment is a digital twin of the real-world building.

6. The building gamification and first responder avatarization method of claim 1 further comprising:
executing the simulation unit on the device of the participant to start the simulated training session; and
simulating, during the simulated training session, the avatar of the participant in the virtual building training environment.

7. The building gamification and first responder avatarization method of claim 6 further comprising recording, during the simulated training session, the simulated training session of the avatar in the virtual building training environment.

8. A detailed building gamification and first responder avatarization method for scanning and gamifying a digital twin of an environment for simulated, virtual training of first responders, said detailed building gamification and first responder avatarization method comprising:
generating a three-dimensional (3D) building model of an actual, real-world building;
exporting a plurality of 3D building model assets from the 3D building model into a modeling platform;
rendering, within the modeling platform, the plurality of assets in a virtual building training environment to represent the 3D building model as a digital twin of the actual, real-world building;
creating, within the modeling platform, a gamified unit of the virtual building training environment;
registering users and managing user accounts for a plurality of first responders configured to participate in simulated training sessions in the virtual building training environment;
setting avatars for which the registered users appear in the virtual building training environment during the simulated training sessions;
setting up a simulation training scenario to apply to the virtual building training environment for a particular simulation training session;
defining training objectives of the simulation training scenario for participants in the particular simulation training session;
designating a plurality of particular users to participate in the particular simulation training session;
configuring a plurality of roles related to the simulation training scenario;
adding randomization elements to the simulation training scenario to enhance realism of the simulation training scenario by simulating unpredictable real-world incidents and events during the particular simulation training session; and
finalizing setup and configuration of the simulation training scenario before starting the particular simulation training session.

9. The detailed building gamification and first responder avatarization method of claim 8, wherein generating the 3D building model comprises scanning an actual, real-world building.

10. The detailed building gamification and first responder avatarization method of claim 9, wherein scanning the actual, real-world building comprises capturing range information by a light detection and ranging (LiDAR) scanner utilized in the actual, real-world building.

11. The detailed building gamification and first responder avatarization method of claim 8, wherein the virtual building training environment comprises a plurality of gamified units that represent a plurality of sections of the actual, real-world building.

12. The detailed building gamification and first responder avatarization method of claim 8, wherein the plurality of roles enable role-based engagement for the plurality of particular users designated to participate in the particular simulation training session.

13. The detailed building gamification and first responder avatarization method of claim 8, wherein finalizing setup and configuration of the particular simulation training scenario comprises compiling the gamified unit, the avatars, the simulation training scenario, the plurality of particular users, the plurality of roles, and the randomization elements into a simulation unit that is configured to execute the virtual building training environment for the plurality of particular users to engage in the particular simulation training session.

14. The detailed building gamification and first responder avatarization method of claim 13 further comprising:
executing the simulation unit;
launching, by the simulation unit, the particular simulation training session;
rendering the virtual building training environment and spawning a plurality of avatars corresponding to the plurality of particular users configured to engage in the particular simulation training session;
recording the particular simulation training session from launch through completion of the particular simulation training scenario;
replaying and reviewing the recording of the particular simulation training session; and debriefing each of the particular users in the plurality of particular users who engaged in the particular simulation training scenario.

15. A digital building twin first responder virtual reality (VR) training method for preparing and utilizing an avatarized, multi-user VR training environment that replicates a real world building or environment for virtual training of first responders and other emergency responders, said digital building twin first responder VR training method comprising:
scanning a building by way of a LiDAR 360 photography scan of every square inch of the building, wherein scanning the building results in generation of a 3D model of the building;
editing the 3D model and placing important asset information into the 3D model to show building assets comprising one or more of exits, entrances, AEDs, fire extinguishers, utility shut off valves, and electrical panels;
training first responders (“users”) how to use and view the 3D model to become familiar with the building before engaging in a life-like training session;
importing an E57 file of the 3D model, generated by the LiDAR 360 photography scan, into a virtual reality software program, wherein importing the E57 file creates a virtualized model of the building configured for training in a particular training session;
creating an avatar for each user;
inviting the avatars of the users into the virtualized model of the building;
installing the avatars of the users in the virtualized model of the building, wherein installing the avatars comprises spawning the avatars in a virtualized meeting place of the virtualized model of the building, wherein the spawned avatars are configured for simultaneous use and interaction during the particular training session;
recording the particular training session from first and third person perspectives of each avatar;
replaying the particular training session in the virtualized model of the building during a watch and record session in which each avatar watches and records the replay (“avatar-watched replay”) of the particular training session; and
replaying the avatar-watched replay of the particular training session to give a third person view of the particular training session.
